(19) United States
(12) Patent Application Publication
(10) Pub. No.: US 2007/0083932 A1
(43) Pub. Date: Apr. 12, 2007

(54) System and method for utilizing a gaming environment for evaluating security policies

(75) Inventors: Chris Aniszczyk, Austin, TX (US); David Perry Greene, Austin, TX (US); Borna Safabakhsh, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation

(21) Appl. No.: 11/245,302

(22) Filed: Oct. 6, 2005

(51) Int. Cl. G06F 11/00

(52) U.S. Cl. 726/25

(57) ABSTRACT

A system and method for utilizing a gaming environment for evaluating security policies is presented. An administrator uses a mapping system to map policy tags corresponding to a policy manager with game tags corresponding to a game manager. In addition, the mapping system configures a participant's game based upon gaming attributes and history data, such as assigning incentives to particular roles or locations, using customized terrains, and configuring screen resolution. Once the mapping system maps policy tags to game tags and configures the game, the mapping system invokes the game and allows the game participant to play the game. While the game participant plays the game, the mapping system identifies policy events, such as a security breach, and rewards the game participant accordingly.

### BACKGROUND OF THE INVENTION

1. Technical Field

The present invention relates to a system and method for utilizing a gaming environment for evaluating security polices. More particularly, the present invention relates to a system and method for mapping game tags to policy tags in order to identify policy events as a result from a user playing a game application.

2. Description of the Related Art

In policy-based networking, a policy is a formal set of statements that define how the network's resources are allocated among its clients (users). For example, clients may be individual users, roles, departments, host computers, or applications. Resources may be allocated based on time of day, client authorization priorities, availability of resources, or other factors. In addition, resource allocation may be static or dynamic based on variations in computer traffic. Network managers typically create policies and policy statements to specify resource allocation, which are stored in a policy repository.

In information technology (IT) environments, security policies describe which users have access to which resources and under what conditions. For example, all employees may have authorization to access a company phone directory, while only top management has authorization to access payroll. Even in a medium size IT environment, the potential for policy errors, policy conflicts, and unanticipated circumstances is exceptionally large. Today, a variety of tools, simulators, and automated methods exist that attempt to reduce the likelihood of explicit errors or to search for possible policy errors. A challenge found, however, is that many problems still go undetected.

Furthermore, a challenge found is that there may be many “common sense” situations that may not be recognized by an intelligent search agent. For example, a global company may provision resource access based upon their management structure, such as all personnel reporting to a vice present are allowed to award stock certificates. In this example, the global company may have a small offshore division, whereby each employee in the division reports to the division manager, which is a vice president. As a result, each employee, regardless of position, is able to award stock certificates.

Therefore, in many cases, the only way to identify a majority of potential security breaches (e.g. policy events) is for an administrator to explicitly evaluate a large number of possible scenarios. A challenge found, however, is that this approach not only drains too much administrator time and attention, but in many cases, the size of the problem exceeds the amount of available resources.

What is needed, therefore, is a system and method that provides an alternative mechanism for administrators to more effectively search for potentially problematic policy events in a computer system.

### SUMMARY

It has been discovered that the aforementioned challenges are resolved using a system and method for mapping game tags to policy tags in order to identify policy events as a result from a user playing a game application. An administrator uses a mapping system to map policy tags corresponding to a policy manager with game tags corresponding to a game manager. A game participant is encouraged, through a game application, to identify policy events. When policy events are identified, the mapping system rewards the game participant if the policy event corresponds to a security breach, which further encourages the game participant to identify more policy events.

Two main components interface to the mapping system, which are a policy manager and a game manager. The policy manager includes roles, resources, and rules. The roles include particular functional roles, such as a manager or a lab administrator. The resources may include information corresponding to particular locations and/or security levels, such as a main office and satellite offices. The rules include rules corresponding to which functional roles have access to which resources.

The game manager includes players, resources, and a simulator. The simulator corresponds to a type of gaming engine (e.g., an open source version) that provides a user interface to a game participant, such as “Reality Factory” or “Cube.” The players include player information corresponding to the open source game that the simulator simulates. The resources include resource information that the players may utilize, such as a wet suit or jet pack.

The mapping system initiates and provides a graphical user interface window to the administrator for mapping policy tags to game tags. For example, game tags may be keys, rooms, or skill levels that correspond to an open source game application, and policy tags may include policies, resources, and roles corresponding to a security policy. In one embodiment, an intelligent interface agent may use past comparisons between policy tags and game tags in order to suggest corresponding tags for the policy manager or game manager.

In addition, the mapping system configures a participant's game scenario based upon gaming attributes and history data, such as assigning incentives to particular roles or locations, using customized terrains, and configuring screen resolution. Once the mapping system maps policy tags to game tags and configures the game, the mapping system invokes the game and allows the game participant to play the game. While the game participant plays the game, the mapping system and game participant identify policy events, such as a security breach, and rewards the game participant accordingly.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a mapping system that maps policy tags with game tags and, as a result, identifies policy events in response to a game participant playing a game;

FIG. 2 is a diagram showing key functional blocks of a mapping system;

FIG. 3 is an interface window showing policy tags mapped to game tags;

FIG. 4 is a high level flowchart showing steps taken in mapping a policy manager to a game manager and a user identifying policy events by playing a game;

FIG. 5 is a flowchart showing steps taken in mapping policy tags to game tags;

FIG. 6 is a flowchart showing steps taken in configuring game attributes;

FIG. 7 is a flowchart showing steps taken a user playing a game and identifying policy events; and

FIG. 8 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

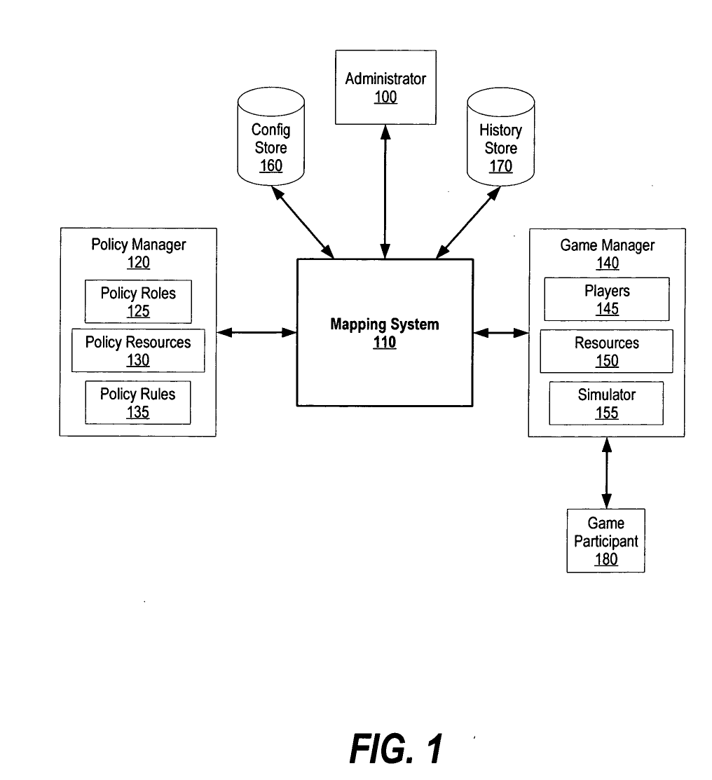

FIG. 1 is a diagram showing a mapping system that maps policy tags with game tags and, as a result, identifies policy events in response to a game participant playing a game. Administrator 100 uses mapping system 110 to map policy tags corresponding to policy manager 120 with game tags corresponding to game manager 140. In turn, policy events are identified in response to game participant 180 playing a game application using game simulator 155.

Policy manager 120 includes policy roles 125, policy resources 130, and policy rules 135. Policy roles 125 include particular functional roles, such as a manager or a lab administrator. Policy resources 130 may include information corresponding to particular locations and/or security levels, such as a main office and satellite offices. Policy rules 135 include rules corresponding to which functional roles have access to which resources.

Game manager 140 includes players 145, resources 150, and simulator 155. Simulator 155 corresponds to a particular gaming engine (e.g., open source game) that provides a user interface to game participant 180. Players 145 include player information corresponding to the open source game that simulator 155 simulates. For example, simulator 155 may correspond to open source games such as “Reality Factory” or “Cube.” Resources 150 include resource information that the players may utilize, such as a wet suit or jet pack, locations, and/or skills.

Administrator 100 uses mapping system 110 to map policy tags to game tags as well as to configure the game environment. Mapping system 110 stores and retrieves previous gaming and mapping data to and from configuration store 160 in order to properly configure the gaming environment. As game participant 180 plays the game application, policy events are identified and stored in history store 170. In turn, mapping system 110 analyzes the identified policy events in order to improve the gaming configuration as well as notify administrator 100.

In one embodiment, when policy manager 120 and game manager 140 are based upon a common format, policy tag to game tag mapping may be an automated process with the possible assistance from administrator 100.

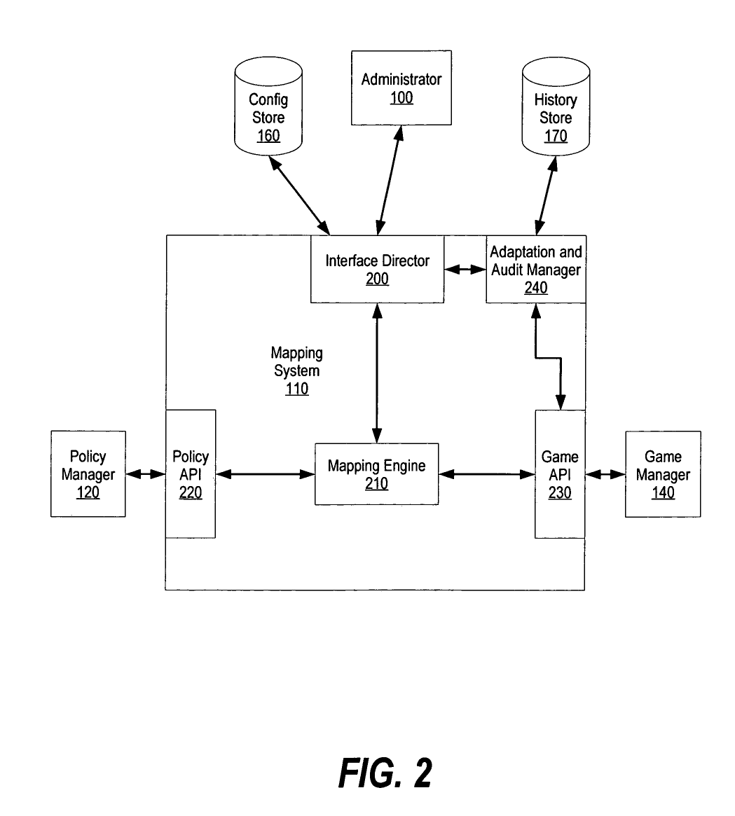

FIG. 2 is a diagram showing key functional blocks of a mapping system. Mapping system 110 is the same as that shown in FIG. 1, and includes interface director 200, mapping engine 210, policy API 220, Game API 230, and adaptation and audit manager 240.

Interface director 200 provides a user interface window to administrator 100 that includes a drag and drop ability to map policy tags to game tags. In addition, interface director 200 may receive particular game incentives, game rules, etc., from administrator 100 that interface director 200 loads into mapping engine 210. Mapping engine 210 provides a conduit between policy manager 120 and game manager 140. Administrator 100, policy manager 120 and game manager 140 are the same as that shown in FIG. 1.

Policy API 220 interfaces with policy manager 120 to establish links related to the features of policy manager 120. For example, the mapping system may use the API to query the policy manager for its policy system and discover information regarding the policy space. Game manager API 230 interfaces with game manager 140 to establish links related to the features of game manager 140. For example, it may be necessary to query game manager 140 for its configuration and capabilities, such as terrains, texture quality, and other features typical of game engines. Game manager 140 may correspond to a number of open source game creation tools, or may be a dedicated gaming environment.

Interface director 200 retrieves configuration data from configuration store 160, and configures mapping engine 210. When a game participant plays the game application and identifies a policy event, adaptation and audit manager 240 log the policy event in history store 170. A policy event may correspond to gaining particular access to a resource. Some policy events are acceptable, while other policy events correspond to a security breach, such as an authorized user accessing a secure database file. In one embodiment, adaptation and audit manager 240 queries policy API 220 as to which policy events corresponds to security breaches.

In addition, adaptation and audit manager 240 may track the amount of game time that a particular functional role and/or resource receives in order to provide incentives for less played functional roles and/or resources. Configuration store 160 and history store 170 are the same as that shown in FIG. 1.

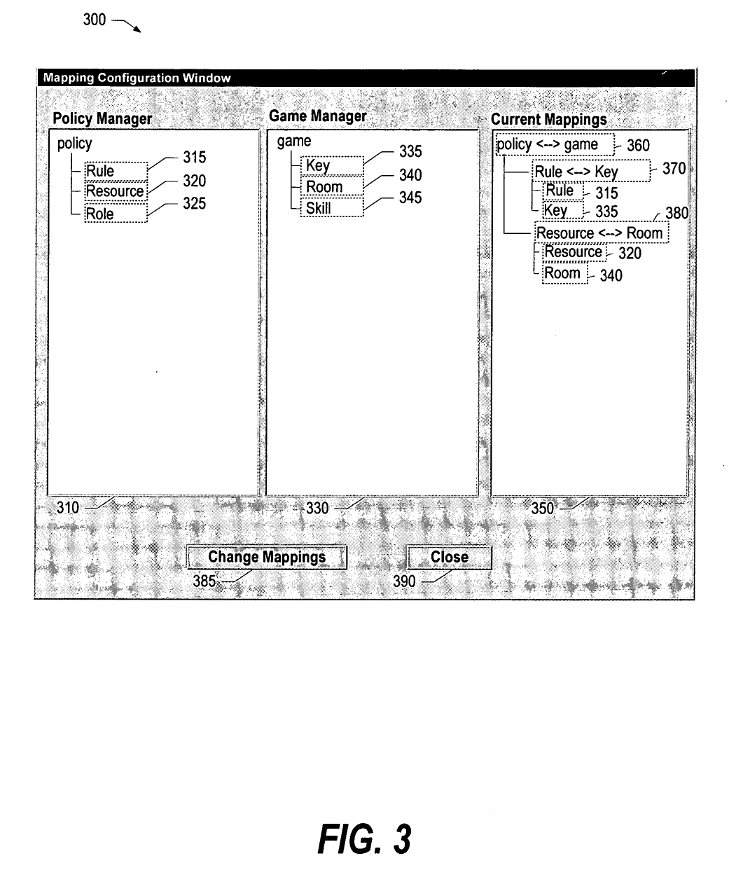

FIG. 3 is an interface window showing policy tags mapped to game tags. An administrator uses configuration window 300 to map policy tags with game tags, which provides a conduit between a policy manager and a game manager to interact. Policy tags and game tags may correspond to an XML-based language that defines constraints and rules for the mappings.

Configuration window 300 includes policy window 310, game window 330, and mapping window 350. Policy window 310 displays policy tags that correspond to a policy manager, which are policy tags 315 through 325. Policy tags 315 through 325 represent resources in a policy model, such as policies, resources, and roles. For example, policy tag 320 may correspond to a particular database.

Game window 330 displays game tags that correspond to a game manager, which are game tags 335 through 345. Game tags 335 through 345 represent resources in a game engine model, such as keys, rooms, and skills. For example, game tag 335 may correspond to a physical key in the game environment that lets one access a door or some kind of token, such as a “magic ring,” that equivalently bestows the same access privileges.

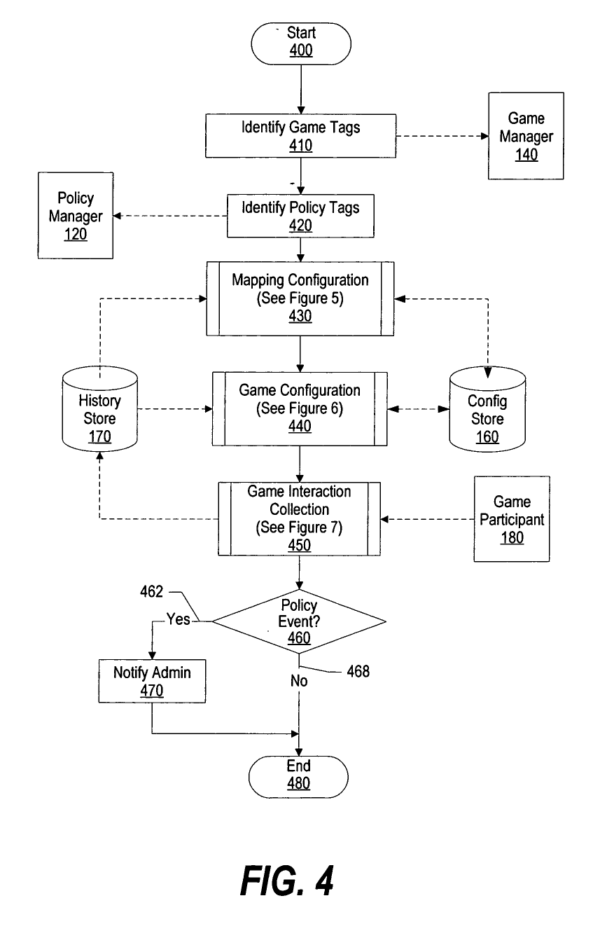

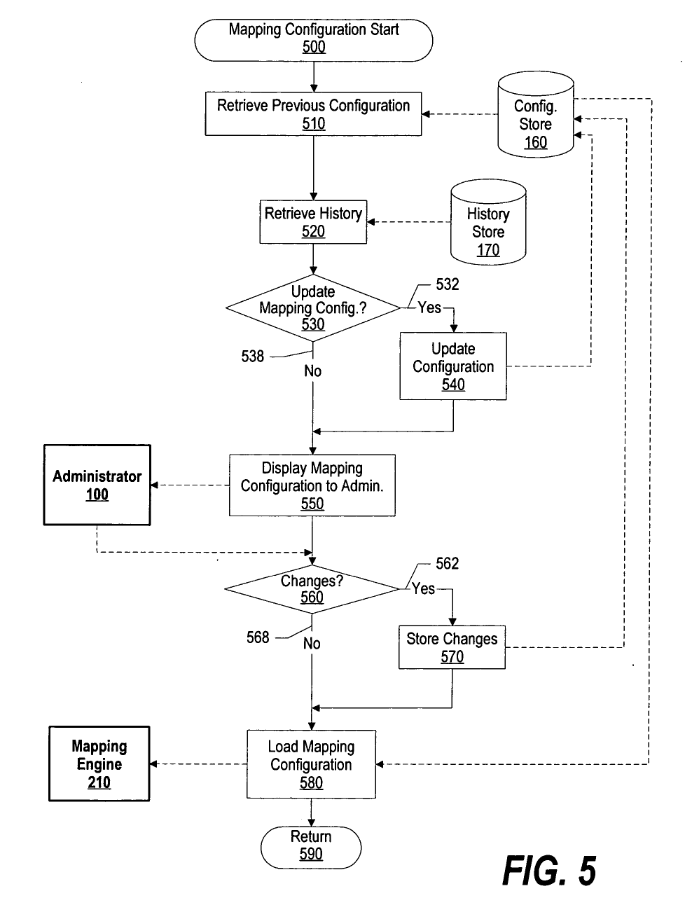

When a mapping system initiates, the mapping system queries a policy manager and a game manager, identifies corresponding policy tags and game tags, and displays the policy tags and game tags in windows 310 and 330, respectively, for an administrator to view (see FIGS. 4, 5, and corresponding text for further details regarding tag retrieval and display). In turn, the administrator is able to view the policy tags and game tags, and determine appropriate tag mapping.

Mapping window 350 includes a visual display of tags that are mapped to each other. Map 360 maps the policy to the game. Map 370 maps policy tag 315 with game tag 335, which embodies a security rule into a key game object. Map 380 maps policy tag 320 with game tag 340. Therefore, a resource in the game environment (e.g., a room) is dictated by a resource in the policy environment. Furthermore, the key (or ring) in the previous mapping may be used to open the room in the game environment if the proper policy mapped to the key would allow access to the resource that is mapped to the room in the game environment.

When an administrator wishes to change mapping configurations, the administrator selects command button 385, which allows the administrator to map policy tags with game tags. When the administrator is finished changing the tag mappings, the administrator selects command button 390 to close window 300.

FIG. 4 is a high level flowchart showing steps taken in mapping a policy manager to a game manager and a user identifying policy events by playing a game. Processing commences at 400, whereupon processing identifies game tags included in game manager 140 using a gaming API (step 410). For example, game tags may be keys, rooms, or skill levels that correspond to an open source game application. At step 420, processing identifies policy tags included in policy manager 120 using a policy API. For example, policy tags may include policies, resources, and roles corresponding to a security policy. Game manager 140 and policy manager 120 are the same as that shown in FIG. 1.

Processing provides a graphical user interface window to an administrator, such as that shown in FIG. 3, for mapping policy tags to game tags by retrieving history data from history store 170 and configuration data from configuration store 160. In one embodiment, an intelligent interface agent may use past comparisons past comparisons between policy tags or game tags in order to suggest corresponding tags for the policy manager or game manager (pre-defined process block 430, see FIG. 5 and corresponding text for further details). History store 170 and configuration store 160 are the same as that shown in FIG. 1.

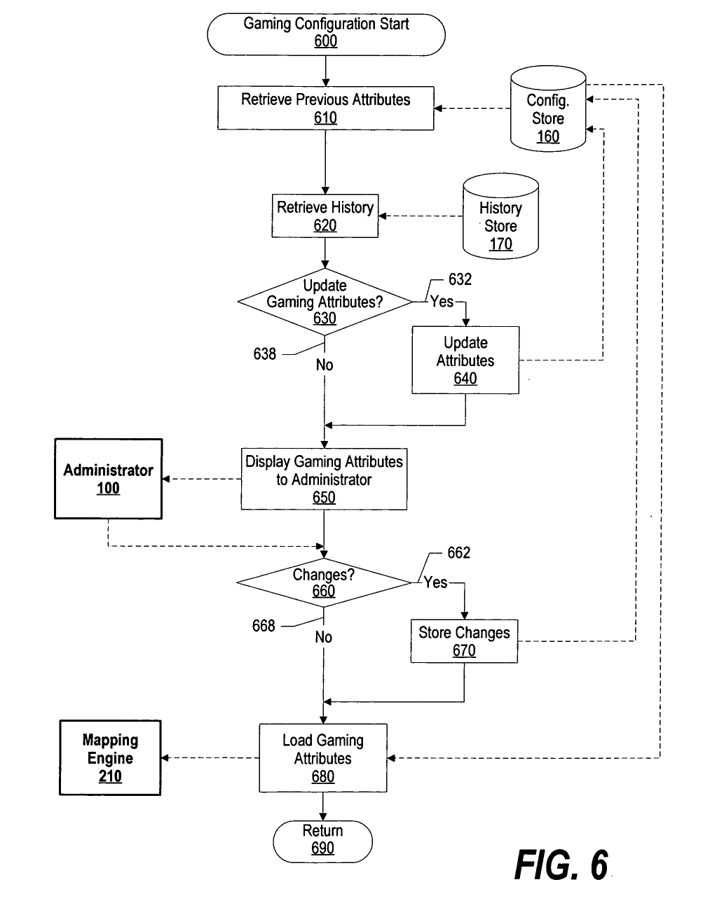

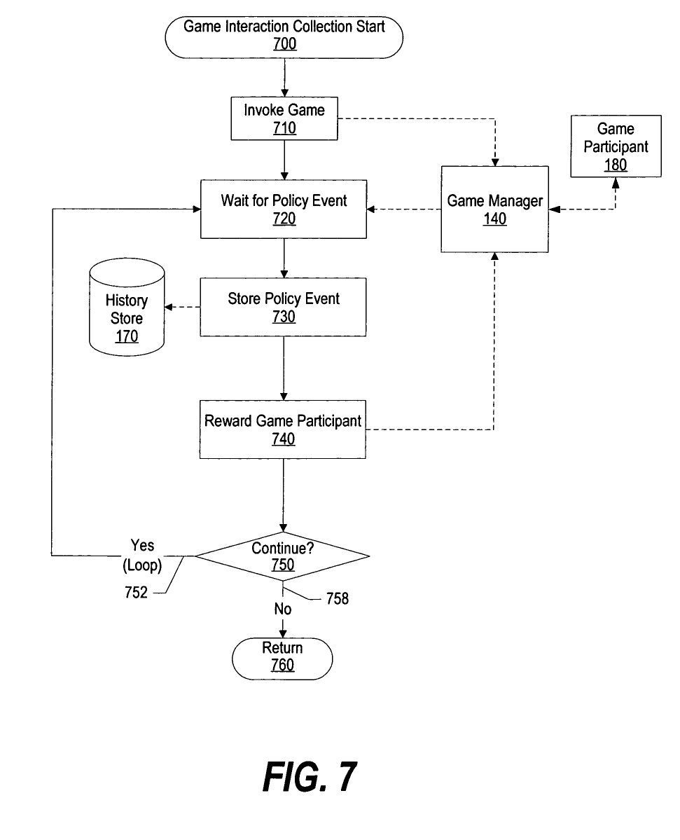

Processing configures the game based upon gaming attributes and history data, such as assigning incentives to particular roles or locations, using customized terrains, and configuring screen resolution (pre-defined process block 440, see FIG. 6 and corresponding text for further details). Once processing maps policy tags to game tags and configures the game, processing invokes the game and allows game participant 180 to play the game. As a result, processing identifies policy events, such as a security breach, based upon game participant 180's results (pre-defined process block 450, see FIG. 7 and corresponding text for further details).

A determination is made as to whether game participant 180 located any policy events (decision 460). If game participant 180 located a policy event, decision 460 branches to “Yes” branch 462 whereupon processing notifies an administrator of the policy event (step 470). On the other hand, if game participant 180 did not locate any policy events, decision 460 branches to “No” branch 468 whereupon processing bypasses administrator notification steps. Processing ends at 480.

FIG. 5 is a flowchart showing steps taken in mapping policy tags to game tags. Processing commences at 500, whereupon processing retrieves previous mapping data from configuration store 160 at step 510. The mapping data includes previous mappings between policy tags and game tags (see FIG. 3 and corresponding text for further details regarding previous mappings). Configuration store 160 is the same as that shown in FIG. 1, and may be stored on a nonvolatile storage area, such as a computer hard drive.

At step 520, processing retrieves history data from history store 170. The history data includes conditions for previously identified policy events. For example, the history data may include the number of policy events or amount of game time corresponding to particular roles and/or resources. History store 170 is the same as that shown in FIG. 1, and may be stored on a nonvolatile storage area, such as a computer hard drive.

A determination is made as to whether to update the mapping data based upon the history data (decision 530). For example, processing may identify that a policy tag should be mapped to a particular game tag in order to increase mapping effectiveness. In this example, an adaptation manager, such as audit and adaptation manager 240 shown in FIG. 2, analyzes an area in the game environment and identifies that the area is not being utilized enough. In this case, the adaptation manager may provide the user with a special skill or weapon to increase the “fun factor” of entering the area.

If processing should update the previous mapping configuration, decision 530 branches to “Yes” branch 532 whereupon processing automatically updates the mapping data in configuration store 160 at step 540. On the other hand, if processing should not update the mapping data, decision 530 branches to “No” branch 538 bypassing automatic updating steps.

At step 550, processing displays the mapping data to administrator 100, such as with the user interface window shown in FIG. 3. Administrator 100 reviews the mapping data, and determines whether to change the mapping data. For example, the administrator may wish to tweak the mapping data in order to improve usability because of user complaints that the game environment may be unsatisfactory (e.g., different layout or skills). Administrator 100 is the same as that shown in FIG. 1.

A determination is made as to whether administrator 100 wishes to make changes to the mapping data (decision 560). If administrator 100 wishes to make mapping data changes, decision 560 branches to “Yes” branch 562 whereupon processing stores the changes in configuration store 160 at step 570. On the other hand, if administrator 100 does not wish to change the mapping data, decision 560 branches to “No” branch 568 bypassing mapping data changing steps.

At step 580, processing loads the mapping data located in configuration store 160 into mapping engine 210. Mapping engine 210 is the same as that shown in FIG. 2, and provides a conduit between a policy manager and a game manager. Processing returns at 590.

FIG. 6 is a flowchart showing steps taken in configuring game attributes. Processing commences at 600, whereupon processing retrieves previous game attributes from configuration store 160 at step 610. The game attributes may include incentives, parameters (screen resolution, etc.), rules, properties and/or constraints. Configuration store 160 is the same as that shown in FIG. 1, and may be stored on a nonvolatile storage area, such as a computer hard drive.

At step 620, processing retrieves history data from history store 170. The history data includes conditions for previously identified policy events. For example, the history data may include the number of policy events or amount of game time corresponding to particular roles and/or resources. History store 170 is the same as that shown in FIG. 1, and may be stored on a nonvolatile storage area, such as a computer hard drive.

A determination is made as to whether to update the gaming attributes based upon the history data (decision 630). For example, processing may identify that a particular role and/or location has not received much game time and, in this example, increase incentives for a game participant to choose the role and/or location. If processing should not update the gaming attributes, decision 630 branches to “No” branch 638 bypassing automatic updating steps.

On the other hand, if processing should update the gaming attributes, decision 630 branches to “Yes” branch 632 whereupon processing automatically updates the gaming attributes in configuration store 160 at step 640. In one embodiment, if a particular section of the game environment is more “fun,” the game section may be mapped to a policy space that requires further test time.

At step 650, processing displays the gaming attributes to administrator 100, which is the same as that shown in FIG. 1. Administrator reviews the gaming attributes, and may decide to change some of the gaming attributes. For example, administrator 100 may know of a recent security breach at a particular location and wish to increase incentives for the particular location in order to identify more policy events and, in turn, prevent future security breaches.

A determination is made as to whether administrator 100 wishes to make changes to the gaming attributes (decision 660). If administrator 100 wishes to make gaming attribute changes, decision 660 branches to “Yes” branch 662 whereupon processing stores the changes in configuration store 160 at step 670. On the other hand, if administrator 100 does not wish to change gaming attributes, decision 660 branches to “No” branch 668 bypassing gaming attributes changing steps.

At step 680, processing loads the gaming attributes located in configuration store 160 into mapping engine 210. Mapping engine 210 is the same as that shown in FIG. 2. Processing returns at 690.

FIG. 7 is a flowchart showing steps taken a user playing a game and identifying policy events. Once a mapping system maps game tags to policy tags and configures a gaming application, game participant 180 plays the game and receives incentives for identifying policy events.

Processing commences at 700, whereupon processing invokes game manager 140 at step 710. Once invoked, game participant 180 plays the game included in game manager 140 based upon particular gaming attributes. For example, game participant 180 may select a functional role that provides more incentives that have been selected by an administrator. In another example, game attributes may provide incentives for game participant to “travel” to different locations that may have different permissions or different access rules. Based upon game participant 180's role and location, game participant 180 may have resource access that they should not. As a result, game participant 180 receives rewards (points, more time, etc,) for identifying policy events. Game manager 140 and game participant 180 are the same as that shown in FIG. 1.

At step 720, processing waits for game participant 180 to identify a policy event. For example, a policy resource may be mapped to a game key and, when a user picks up a game key, it qualifies as a policy event due to the mapping. In addition, game participants may identify arbitrary game moments and history that are saved as event snapshots for later reviewing as policy events. When processing receives a policy event, processing stores the event in history store 170 for future analysis (step 730). When the policy event corresponds to a security breach, processing rewards game participant 180 for identifying the policy event at step 740, such as increasing game time. History store 170 is the same as that shown in FIG. 1.

A determination is made as to whether game participant 180 wishes to continue playing the game or whether the game time has expired (decision 750). If processing should continue, decision 750 branches to “Yes” branch 752, which loops back to wait for more policy events. This looping continues until processing should terminate, at which point decision 750 branches to “No” branch 758 whereupon processing returns at 760.

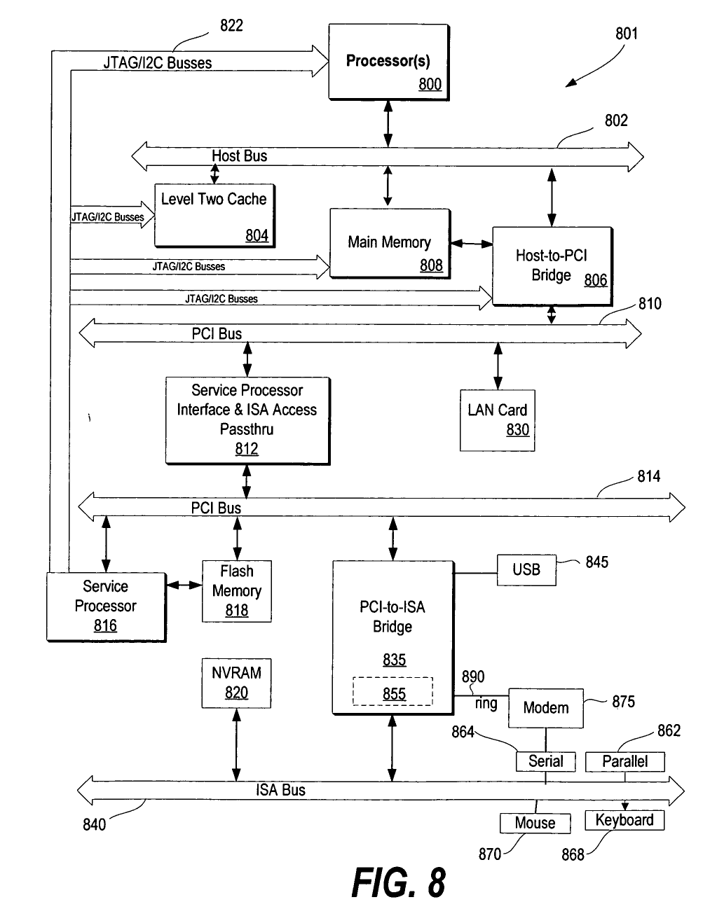

FIG. 8 illustrates information handling system 801 which is a simplified example of a computer system capable of performing the computing operations described herein. Computer system 801 includes processor 800 which is coupled to host bus 802. A level two (L2) cache memory 804 is also coupled to host bus 802. Host-to-PCI bridge 806 is coupled to main memory 808, includes cache memory and main memory control functions, and provides bus control to handle transfers among PCI bus 810, processor 800, L2 cache 804, main memory 808, and host bus 802. Main memory 808 is coupled to Host-to-PCI bridge 806 as well as host bus 802. Devices used solely by host processor(s) 800, such as LAN card 830, are coupled to PCI bus 810. Service Processor Interface and ISA Access Pass-through 812 provides an interface between PCI bus 810 and PCI bus 814. In this manner, PCI bus 814 is insulated from PCI bus 810. Devices, such as flash memory 818, are coupled to PCI bus 814. In one implementation, flash memory 818 includes BIOS code that incorporates the necessary processor executable code for a variety of low-level system functions and system boot functions.

PCI bus 814 provides an interface for a variety of devices that are shared by host processor(s) 800 and Service Processor 816 including, for example, flash memory 818. PCI-to-ISA bridge 835 provides bus control to handle transfers between PCI bus 814 and ISA bus 840, universal serial bus (USB) functionality 845, power management functionality 855, and can include other functional elements not shown, such as a real-time clock (RTC), DMA control, interrupt support, and system management bus support. Nonvolatile RAM 820 is attached to ISA Bus 840. Service Processor 816 includes JTAG and I2C busses 822 for communication with processor(s) 800 during initialization steps. JTAG/I2C busses 822 are also coupled to L2 cache 804, Host-to-PCI bridge 806, and main memory 808 providing a communications path between the processor, the Service Processor, the L2 cache, the Host-to-PCI bridge, and the main memory. Service Processor 816 also has access to system power resources for powering down information handling device 801.

Peripheral devices and input/output (I/O) devices can be attached to various interfaces (e.g., parallel interface 862, serial interface 864, keyboard interface 868, and mouse interface 870 coupled to ISA bus 840. Alternatively, many I/O devices can be accommodated by a super I/O controller (not shown) attached to ISA bus 840.

In order to attach computer system 801 to another computer system to copy files over a network, LAN card 830 is coupled to PCI bus 810. Similarly, to connect computer system 801 to an ISP to connect to the Internet using a telephone line connection, modem 885 is connected to serial port 864 and PCI-to-ISA Bridge 835.

While the computer system described in FIG. 8 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
identifying a game tag that is associated with a game application;
identifying a policy tag that is associated with a policy manager;
mapping the game tag to the policy tag;
identifying, based upon the mapping, a policy event associated with the policy manager in response to a user playing the game application.

2. The method of claim 1 wherein the mapping further comprises:
associating a game incentive to the policy tag, wherein the game incentive provides an incentive for the user to utilize a policy resource that is associated with the policy manager.

3. The method of claim 1 further comprising:
detecting that the policy event is associated with a security breach;
identifying, in response to the detecting; a reward that is associated with the identified policy event; and
providing the identified reward to the user.

4. The method of claim 3 further comprising:
identifying subsequent policy events from the user playing the game application as a result from the user receiving the reward.

5. The method of claim 1 wherein the mapping further comprises:
identifying a plurality of game tags associated with the game application, the game tag included in the plurality of game tags;
identifying a plurality of policy tags associated with the policy manager, the policy tag included in the plurality of policy tags;
retrieving history data, the history data including information regarding the plurality of policy tags and the plurality of game tags; and
determining which policy tags to map to which game tags based upon the history data.

6. The method of claim 5 further comprising:
detecting, based upon the history data, that an area included in the game application is underutilized; and
providing, in response to the detecting, the user with an incentive to utilize the area.

7. The method of claim 1 wherein the mapping further comprises:
identifying a plurality of policy events;
determining parameter combinations that correspond to the policy events, the parameter combinations including a parameter that is selected from the group consisting of a role, a resource, and a condition.

8. A computer program product comprising:
a computer operable medium having computer readable code, the computer readable code being effective to:
identify a game tag that is associated with a game application;
identify a policy tag that is associated with a policy manager;
map the game tag to the policy tag;
identify, based upon the mapping, a policy event associated with the policy manager in response to a user playing the game application.

9. The computer program product of claim 8 wherein the computer readable code is further effective to:
associating a game incentive to the policy tag, wherein the game incentive provides an incentive for the user to utilize a policy resource that is associated with the policy manager.

10. The computer program product of claim 8 wherein the computer readable code is further effective to:
detect that the policy event is associated with a security breach;
identify, in response to the detection, a reward that is associated with the identified policy event; and
provide the identified reward to the user.

11. The computer program product of claim 10 wherein the computer readable code is further effective to:
identify subsequent policy events from the user playing the game application as a result from the user receiving the reward.

12. The computer program product of claim 8 wherein the computer readable code is further effective to:
identify a plurality of game tags associated with the game application, the game tag included in the plurality of game tags;
identify a plurality of policy tags associated with the policy manager, the policy tag included in the plurality of policy tags;
retrieve history data, the history data including information regarding the plurality of policy tags and the plurality of game tags; and
determine which policy tags to map to which game tags based upon the history data.

13. The computer program product of claim 12 wherein the computer readable code is further effective to:
detect, based upon the history data, that an area included in the game application is underutilized; and
provide, in response to the detecting, the user with an incentive to utilize the area.

14. The computer program product of claim 8 wherein the computer readable code is further effective to:
identify a plurality of policy events; determine parameter combinations that correspond to the policy events, the parameter combinations including a parameter that is selected from the group consisting of a role, a resource, and a condition.

15. An information handling system comprising:
one or more processors;
a memory accessible by the processors;
one or more nonvolatile storage devices accessible by the processors; and
a policy event detection tool for detecting policy events, the policy event detection tool being effective to:
identify a game tag that is associated with a game application;
identify a policy tag that is associated with a policy manager;
map the game tag to the policy tag;
store the mapping in one of the nonvolatile storage devices; and
identify, based upon the mapping, a policy event associated with the policy manager in response to a user playing the game application.

16. The information handling system of claim 15 wherein the policy event detection tool is further effective to: retrieve a game incentive from one of the nonvolatile storage devices to associate with the policy tag, wherein the game incentive provides an incentive for the user to utilize a policy resource that is associated with the policy manager.

17. The information handling system of claim 15 wherein the policy event detection tool is further effective to:
detect that the policy event is associated with a security breach;
identify, in response to the detection, a reward from one of the nonvolatile storage devices that is associated with the identified policy event; and
provide the selected reward to the user.

18. The information handling system of claim 17 wherein the policy event detection tool is further effective to:
identify subsequent policy events from the user playing the game application as a result from the user receiving the reward.

19. The information handling system of claim 15 wherein the policy event detection tool is further effective to:
identify a plurality of game tags associated with the game application, the game tag included in the plurality of game tags;
identify a plurality of policy tags associated with the policy manager, the policy tag included in the plurality of policy tags;
retrieve history data from one of the nonvolatile storage devices, the history data including information regarding the plurality of policy tags and the plurality of game tags; and
determine which policy tags to map to which game tags based upon the history data.

20. The information handling system of claim 19 wherein the policy event detection tool is further effective to:
detect, based upon the history data, that an area included in the game application is underutilized; and
provide, in response to the detecting, the user with an incentive to utilize the area.
